(19) United States
(12) Patent Application Publication
(10) Pub. No.: US 2020/0172380 A1
(43) Pub. Date: Jun. 4, 2020

(54) COLUMN-INTEGRATED STEP FOR ELEVATOR SYSTEMS

(71) Applicant: Otis Elevator Company, Farmington, CT (US)

(72) Inventors: Clement Schach, Orleans (FR); Stephane Brieuc, Poilly Lez Gien (FR); Valerie Mauguen, Sully Sur Loire (FR)

(21) Appl. No.: 16/688,277

(22) Filed: Nov. 19, 2019

(30) Foreign Application Priority Data
Nov. 29, 2018 (EP) 18306585.3

(51) Int. Cl. B66B 13/30; B66B 13/14; B66B 5/00

(52) U.S. Cl. CPC B66B 13/30; B66B 5/0087; B66B 13/14

(57) ABSTRACT

An elevator system is described. The system includes a landing door having a landing door lintel, a landing door sill, and a landing door column, a landing door lock located in one of the landing door lintel and the landing door column, and a column-integrated step integrated into the landing door column, wherein the column-integrated step is deployable from a stowed state to a deployed state, wherein when in the deployed state, the column-integrated step provides a step for access to the landing door lock.

### BACKGROUND

The subject matter disclosed herein generally relates to elevator systems and, more particularly, to column-integrated step access systems and devices for access to locks and access to perform elevator maintenance.

Elevator systems include locking mechanisms that are useable by mechanics, technicians, and other authorized persons. The locking mechanisms can be part of lintels or door columns and located to prevent easy access thereto. However, it may be necessary to locate the position of a lock at no more than maximum height, to enable ease of use and access to the lock. However, if a lock is located above such maximum height, then a ladder or other device may be required to access the lock. Accordingly, it may be advantageous to provide improved mechanisms for accessing elevator landing door locks.

Further, once the elevator landing doors are opened, a mechanic may be required to enter an elevator shaft to perform inspections, repairs, or other maintenance. It may be dangerous to enter the elevator shaft, and thus reducing the exposure or requirements of mechanics or other personnel to enter an elevator shaft may be beneficial.

### SUMMARY

According to some embodiments, elevator systems are provided. The elevator systems include a landing door having a landing door lintel, a landing door sill, and a landing door column, a landing door lock located in one of the landing door lintel and the landing door column, and a column-integrated step integrated into the landing door column, wherein the column-integrated step is deployable from a stowed state to a deployed state, wherein when in the deployed state, the column-integrated step provides a step for access to the landing door lock.

In addition to one or more of the features described above, or as an alternative, further embodiments of the elevator systems may include that the column-integrated step has a cover plate configured to engage with a surface of the landing door column when in the stowed state and a support element configured to support the cover plate when in the deployed state to form the step.

In addition to one or more of the features described above, or as an alternative, further embodiments of the elevator systems may include that the cover plate includes a step surface.

In addition to one or more of the features described above, or as an alternative, further embodiments of the elevator systems may include that the step surface provides at least one of anti-slip or grip properties to the cover plate.

In addition to one or more of the features described above, or as an alternative, further embodiments of the elevator systems may include that the support element includes an engagement element configured to engage with the landing door sill when in the deployed state.

In addition to one or more of the features described above, or as an alternative, further embodiments of the elevator systems may include a step cavity in the landing door column configured to receive the column-integrated step when in the stowed state.

In addition to one or more of the features described above, or as an alternative, further embodiments of the elevator systems may include a step lock configured to secure the column-integrated step to the landing door column when in the stowed state.

In addition to one or more of the features described above, or as an alternative, further embodiments of the elevator systems may include that the column-integrated step is hingedly connected to the landing door column.

In addition to one or more of the features described above, or as an alternative, further embodiments of the elevator systems may include that the column-integrated step is configured to support up to 200 kg when in the deployed state.

In addition to one or more of the features described above, or as an alternative, further embodiments of the elevator systems may include that when in the deployed state the column-integrated step defines a step about 0.1 m above the landing door sill.

In addition to one or more of the features described above, or as an alternative, further embodiments of the elevator systems may include that when in the deployed state the column-integrated step defines a step that is about 2.7 m below the landing door lintel.

In addition to one or more of the features described above, or as an alternative, further embodiments of the elevator systems may include that a distance from the landing door lintel to the landing door sill is about 2.8 m.

In addition to one or more of the features described above, or as an alternative, further embodiments of the elevator systems may include a plurality of additional landings, wherein each additional landing includes a column-integrated step in a respective landing door column.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing floor of an elevator system with a hall call panel that may employ various embodiments of the present disclosure;

FIG. 3 is a schematic illustration of a lock of an elevator system that can incorporate embodiments of the present disclosure;

FIG. 4A is a schematic illustration of a landing of an elevator system having a column-integrated step in accordance with an embodiment of the present disclosure, with the column-integrated step in a stowed state;

FIG. 4B is a schematic illustration of the column-integrated step of FIG. 4A shown in a deployed state;

FIG. 5A illustrates a column-integrated step in accordance with an embodiment of the present disclosure in a stowed state;

FIG. 5B illustrates the column-integrated step of FIG. 5A in a deployed state; and

FIG. 6 illustrates a mechanic using a column-integrated step in accordance with an embodiment of the present disclosure to perform a maintenance operation.

### DETAILED DESCRIPTION

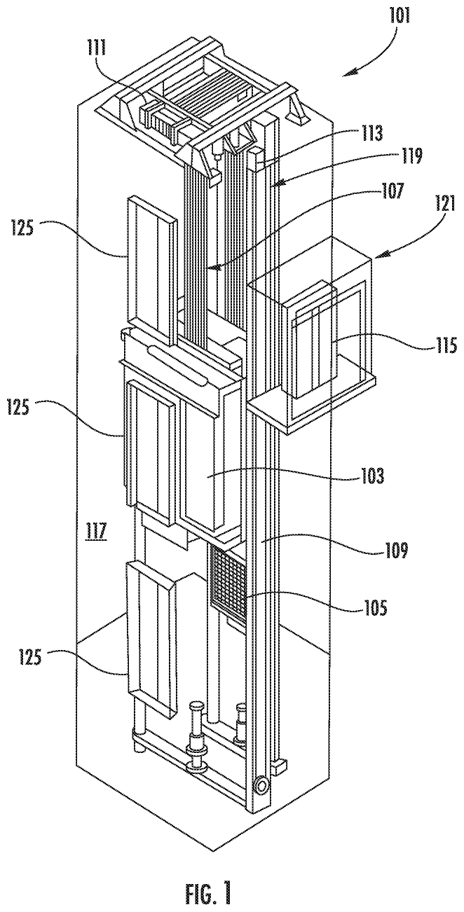

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the movement of the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

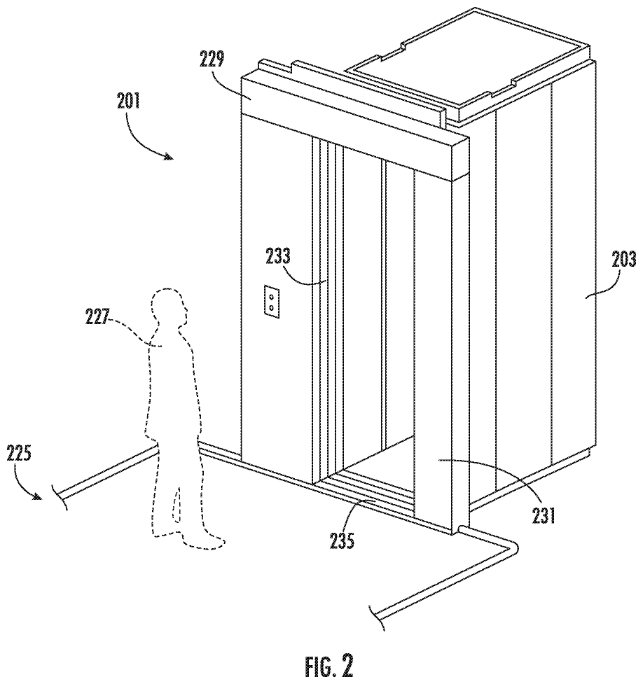

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a passenger or mechanic 227 that desires to travel to another floor within a building or perform maintenance on a portion of the elevator system 201. In some situations, the mechanic 227 may wish to lock a feature of the elevator system, e.g., the elevator doors, an elevator trap, etc., such that the feature(s) cannot be opened or closed (e.g., to prevent unauthorized persons from accessing the elevator system 201 or portions thereof). For example, such situation may arise when the mechanic 227 wishes to access the elevator car and/or shaft to perform maintenance. Such control or locking can be achieved by a lock hole in a landing door lintel 229 of the elevator system 201 (which may be located at one or more landings 225). Also shown FIG. 2 is a landing door column 231 that frames and supports a landing door 233, as will be appreciated by those of skill in the art. The landing door 233 may move or be guided along the landing door lintel 229 and a landing door sill 235, as will be appreciated by those of skill in the art.

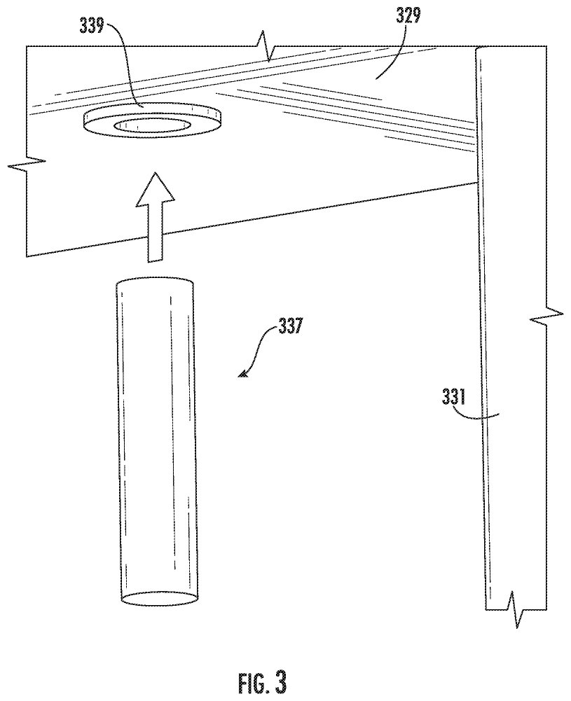

Turning to FIG. 3, an access device 337 for use with a lock 339 of an elevator system in accordance with an embodiment of the present disclosure is shown. Although shown and described herein as a key-type “access device,” the term “access device” may refer to any access key, tool, or other mechanism that can be used to lock/unlock an elevator landing door. As shown, the lock 339 is an elevator door lock located within a landing door lintel 329. In other configurations, the lock 339 may be located in a landing door column 331 of an elevator doorway. The access device 337 is configured to fit within an aperture or keyway of the lock 339. Those of skill in the art will appreciate that the locks and keys described herein are not limited to door locks, but rather may be employed in any locks of elevator systems. For example, in other configurations, the lock may be part of a door column or trap inside an elevator car or may be a lock of other parts of elevator systems. Thus, FIG. 3 is merely illustrative and not intended to be limiting. The lock 339 can include access prevention devices or mechanisms configured within the lock 339 to prevent the access device 337 from entering the aperture of the lock 339. As appreciated by those of skill in the art, the access device 337 is specifically designed for engagement and use with the specific lock 339.

To unlock a landing door lock, such as shown in FIG. 3, an authorized person must be able to reach the lock. In some configurations, the location of the lock may be higher than is reachable without aid. For example, when the lock is located in a landing door lintel or when the lock is placed near the lintel or high on a landing door column, some kind of assistance may be required for a person to engage the access device (e.g., key) with the lock. Such assistance may be in the form of a ladder or step ladder. However, use of a ladder or step ladder may be cumbersome or inefficient, and thus improved mechanisms to aid operation and access to landing door locks of elevators systems may be useful.

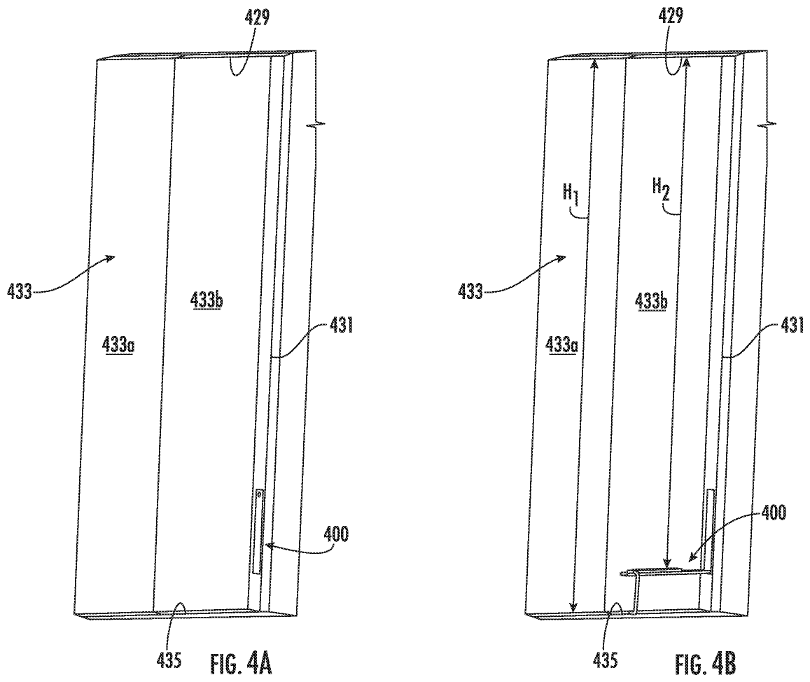

Turning now to FIGS. 4A-4B, schematic illustrations of a column-integrated step 400 for use in maintenance operations of an elevator are shown. The column-integrated step 400 is a foldable or deployable system that integrates a step that a user can stand on to reach a landing door lock, to thus unlock the landing door. FIG. 4A illustrates the column-integrated step 400 in a stowed state and FIG. 4B illustrates the column-integrated step 400 in a deployed state.

The column-integrated step 400 is integrated into a landing door column 431 of a frame of a landing door 433 of an elevator system. The frame of the landing door 433 includes a landing door sill 435 and a landing door lintel 429, with two landings door panels 433a, 433b. A landing door lock may be located in the landing door lintel 429 (e.g., as shown in FIG. 3) or at a relatively high location along the landing door column 431 (e.g., proximate the landing door lintel 429). The column-integrated step 400 provides for easy access to the landing door lock. As shown in FIG. 4B, a distance between the landing door sill 435 and the landing door lintel 429 is a first height H₁. The first height H₁ may be too large for a user to easily reach the landing door lock. Accordingly, the column-integrated step 400 is deployable as shown in FIG. 4B to reduce the distance to the landing door lock to a second height H₂. That is, the distance from the column-integrated step 400 to the landing door lintel 429 is the second height H₂, which is less than the first height H₁. As such, the maximum distance a user of the column-integrated step 400 employs or is required to reach will be less than the maximum distance if no column-integrated step 400 was present.

In some non-limiting examples, the first height H₁ may be about 2.8 m and the second height H₂ may be about 2.7 m. That is, in this example, the column-integrated step 400 may reduce the distance to the landing door lintel 429 by about 0.1 m. Stated another way, when deployed, the column-integrated step 400 may form a step or standing surface about 0.1 m from the landing door sill 435. This is merely an example, and other dimensions may be employed without departing from the scope of the present disclosure. In some embodiments, the column-integrated step 400 may be used as a platform or other structure to support a step or ladder. That is, the column-integrated step 400 may reduce the distance to the location of the lock in a lintel or column, but a technician or mechanic may still use other devices to gain access to the lock, in addition to the column-integrated step. Further, in some embodiments, a technician or mechanic may employ an oversized (e.g., long) key that is able to reach a portion of the distance between the sill and the lock, and by standing on the column-integrated step 400, the user may reach any additional distance required to access the lock.

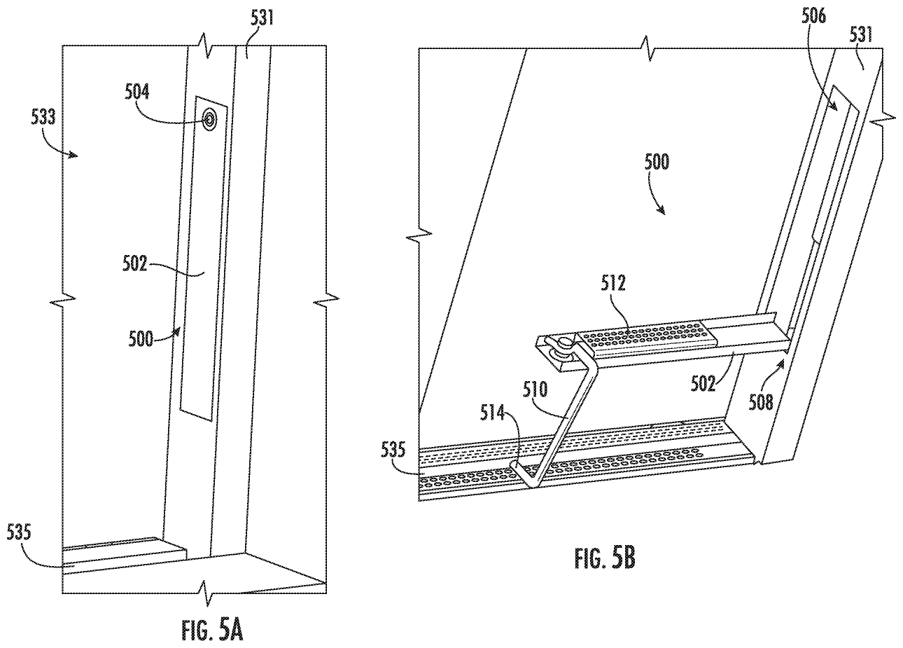

Turning now to FIGS. 5A-5B, enlarged schematic illustrations of a column-integrated step 500 in accordance with an embodiment of the present disclosure are shown. The column-integrated step 500 is similar to that shown in FIGS. 4A-4B, and is usable to reduce a distance or height from a standing location to a landing door lock of an elevator system. FIG. 5A illustrates the column-integrated step 500 in a stowed state and FIG. 5B illustrates the column-integrated step 500 in a deployed state.

As shown in FIG. 5A, the column-integrated step 500 is integrated into a landing door column 531 which is part of a frame for a landing door 533. The column-integrated step 500 is located proximate a landing door sill 535. The column-integrated step 500 includes a cover plate 502 and a step lock 504. The step lock 504 secures the column-integrated step 500 into the landing door column 531. In some embodiments, the step lock 504 may be similar to the type lock used for the landing door (e.g., landing door lock 339 shown in FIG. 3), and thus only a single key is required to unlock the column-integrated step 500 and the landing door lock. The cover plate 502 may provide for a smooth or flush engagement of the column-integrated step 500 within a step cavity 506 (shown in FIG. 5B) such that the cover plate 502 covers the step cavity 506 and provides for a substantially smooth and/or uniform surface of the landing door column 531.

After unlocking the step lock 504, the cover plate 502 may fold or deploy to form a step as shown in FIG. 5B. The cover plate 502, in this embodiment, is hingedly connected to the landing door column 531 at a step hinge 508. The column-integrated step 500 includes a support element 510 and a step surface 512. The support element 510 may be a support arm or support leg that extends from the cover plate 502 or is attached to the cover plate 502 to provide support to the cover plate 502 and the step surface 512. In some non-limiting examples, the support element 510, in combination with the cover plate 502, may be configured to support up to 200 kg, and in some embodiments, may be configured to support up to 150 kg. The step surface 512 may be an integral part of the cover plate 502 or may be a separate element attached to the cover plate 502. In some embodiments, the step surface 512 is textured to provide anti-slip or grip properties to the column-integrated step 500.

In some embodiments, as shown, the support element 510 can include a sill engagement element 514. The sill engagement element 514 may be a footing or extension that is configured to provide a firm and stable support to the column-integrated step 500. In some embodiments, the sill engagement element 514 may physically attach or connect to the landing door sill 535, such as by a fasteners, clasp, hook-and-loop, etc., as will be appreciated by those of skill in the art.

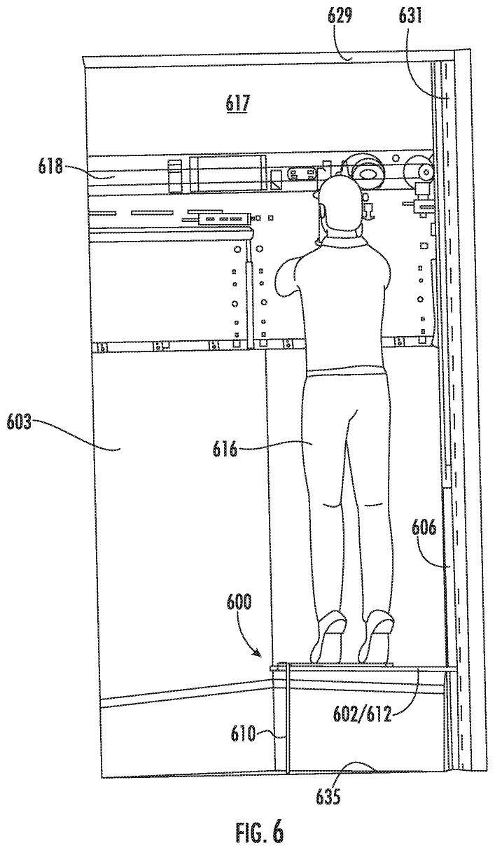

Turning now to FIG. 6, a schematic illustration of a mechanic 616 using a column-integrated step 600 in accordance with an embodiment of the present disclosure is shown. As shown, the mechanic 616 is standing on a cover plate 602/step surface 612 to gain access to components 618 of an elevator car 603. The mechanic 616 is standing in a landing door area, with a landing door opened. The landing door may be opened through access at a landing door lock located in a landing door lintel 629. To access the landing door lock, the mechanic 616 would unlock and deploy the column-integrated step 600. That is, the mechanic 616 can unlock a step lock and fold down the cover plate 602/step surface 612, and deploy a support element 610 to engage with a landing door sill 635. Then, standing on the column-integrated step 600, the mechanic 616 can reach the landing door lock, whether it is located in the landing door lintel 629 or relatively high on a landing door column 631.

Further, as shown, in FIG. 6, the mechanic 616 is able to perform maintenance on components of the elevator car 603 from the landing. That is, the mechanic 616 is not required to enter an elevator shaft 617 to perform the maintenance on the components 618 of the elevator car 603. After completion of the maintenance work, the mechanic 616 can fold or collapse the column-integrated step 600 such that the parts thereof fit within a step cavity 606 located in the landing door column 631. The step lock can be used to secure the column-integrated step 600 in the landing door column 631.

As provided herein, embodiments of the present disclosure are directed to column-integrated steps that enable ease of access to landing door locks and elevator maintenance from a landing. The column-integrated step is integrated into a column of the landing such that when not in use, the integrated step is not visible or has minimal visual impact and further may be structurally flush or substantially flush with the column. The column-integrated step may be secured into a stowed state using a step lock, as described above. When use is required, a key, such as a triangular key as known in the art, may be used to unlock and deploy the column-integrated step. The deployed column-integrated step may provide sufficient support and stability to support the weight of a mechanic (plus tools) and provide a steady and sturdy platform or step to stand upon.

Advantageously, embodiments described herein enable a simple and efficient mechanism for access to landing door locks at elevator system landings. The column-integrated step can eliminate the need for a mechanic to carry a ladder or step stool or similar device when performing maintenance. Moreover, advantageously, the column-integrated step may enable larger or taller elevator landings, while maintaining accessibility to a landing door lock. Further, the column-integrated steps of the present disclosure may be implemented at one or more than one or all of the landings of a given elevator system, thus providing easy access to a landing door lock at each landing of the system. Furthermore, the step lock prevents unauthorized access or operation of the column-integrated step of the present disclosure.

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. An elevator system comprising:
a landing door having a landing door lintel, a landing door sill, and a landing door column;
a landing door lock located in one of the landing door lintel and the landing door column; and
a column-integrated step integrated into the landing door column, wherein the column-integrated step is deployable from a stowed state to a deployed state, wherein when in the deployed state, the column-integrated step provides a step for access to the landing door lock.

2. The elevator system of claim 1, wherein the column-integrated step comprises:
a cover plate configured to engage with a surface of the landing door column when in the stowed state; and
a support element configured to support the cover plate when in the deployed state to form the step.

3. The elevator system of claim 2, wherein the cover plate includes a step surface.

4. The elevator system claim 3, wherein the step surface provides at least one of anti-slip or grip properties to the cover plate.

5. The elevator system of claim 4, wherein the support element includes an engagement element configured to engage with the landing door sill when in the deployed state.

6. The elevator system of claim 1, further comprising a step cavity in the landing door column configured to receive the column-integrated step when in the stowed state.

7. The elevator system of claim 1, further comprising a step lock configured to secure the column-integrated step to the landing door column when in the stowed state.

8. The elevator system of claim 1, wherein the column-integrated step is hingedly connected to the landing door column.

9. The elevator system of claim 1, wherein the column-integrated step is configured to support up to 200 kg when in the deployed state.

10. The elevator system of claim 1, wherein when in the deployed state the column-integrated step defines a step about 0.1 m above the landing door sill.

11. The elevator system of claim 1, wherein when in the deployed state the column-integrated step defines a step that is about 2.7 m below the landing door lintel.

12. The elevator system of claim 1, wherein a distance from the landing door lintel to the landing door sill is about 2.8 m.

13. The elevator system of claim 1, further comprising a plurality of additional landings, wherein each additional landing includes a column-integrated step in a respective landing door column.

14. The elevator system of claim 2, wherein the support element includes an engagement element configured to engage with the landing door sill when in the deployed state.

15. The elevator system of claim 3, wherein the support element includes an engagement element configured to engage with the landing door sill when in the deployed state.

16. The elevator system of claim 2, further comprising a step cavity in the landing door column configured to receive the column-integrated step when in the stowed state.

17. The elevator system of claim 2, further comprising a step lock configured to secure the column-integrated step to the landing door column when in the stowed state.

18. The elevator system of claim 2, wherein the column-integrated step is hingedly connected to the landing door column.

19. The elevator system of claim 2, wherein the column-integrated step is configured to support up to 200 kg when in the deployed state.

20. The elevator system of claim 2, wherein when in the deployed state the column-integrated step defines a step about 0.1 m above the landing door sill.
